(19) United States
(12) Patent Application Publication
(10) Pub. No.: US 2007/0121026 A1
(43) Pub. Date: May 31, 2007

(54) Liquid crystal display with high-profile elastic gasket

(75) Inventors: Hsueh-Tien Chang, Miao-Li (TW); Cheng-Fan Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/604,421

(22) Filed: Nov. 27, 2006

(30) Foreign Application Priority Data
Nov. 25, 2005 (TW) 94141480

(51) Int. Cl. G02F 1/1333

(52) U.S. Cl. 349/58

(57) ABSTRACT

An exemplary liquid crystal display (3) includes an elastic gasket (37), a liquid crystal panel (34), a frame (36), and a housing (32). The liquid crystal panel is surrounded by the elastic gasket, and the elastic gasket and the liquid crystal panel are all received in a frame (32). A top of the elastic gasket is higher than a top of the frame. The housing receives the frame, the elastic gasket, and the liquid crystal panel. An underside of a top wall of the housing abuts the top of the elastic gasket and be spaced from the top of the frame.

### FIELD OF THE INVENTION

The present invention relates to liquid crystal displays, and more particularly to a liquid crystal display having an elastic gasket.

### BACKGROUND

Liquid crystal displays (LCDs) generally have advantages of lightness in weight, a thin profile, flexible sizing, and low power consumption. For these reasons, LCDs are widely used in products such as laptops, personal digital assistants, mobile phones, and so on.

Referring to FIG. 7, a conventional liquid crystal display 1 includes a front frame 13, a rear frame 16, a substantially rectangular elastic gasket 17, a liquid crystal panel 14, and a housing 12 defining an opening (not labeled) at a position corresponding to the liquid crystal panel 14.

The elastic gasket 17 has an L-shaped through slit 172 commonly defined in one long side and one short side thereof. The elastic gasket 17 surrounds the liquid crystal panel 14, and is received in the front and rear frames 13, 16. The housing 12 receives the gasket 17, the liquid crystal panel 14, and the front and rear frames 13, 16.

The liquid crystal panel 14 includes a first substrate 141 joined on a second substrate 143. A size of the second substrate 143 is larger than that of the first substrate 141, whereby an L-shaped bonding part 144 is defined at two adjacent sides of the second substrate 143. A plurality of connecting members 147 each having a driving chip 148 disposed thereon connects the bonding part 144 with an L-shaped circuit board assembly 145 provided adjacent to the bonding part 144. The rear frame 16 includes a protrusion 161 at a corner thereof. The protrusion 161 is positioned according to a through hole 176 of an extension block 174 provided at a corner of the elastic gasket 17.

A process of assembling the liquid crystal display 1 is as follows. Firstly, the liquid crystal panel 14 is surrounded by and fixed within the elastic gasket 17, such that the circuit board assembly 145 protrudes out through the slit 172 of the elastic gasket 17. Secondly, the combined elastic gasket 17 and liquid crystal panel 14 are received in the rear frame 16. The protrusion 161 of the rear frame 16 is wedged in the through hole 176 of the extension part 174, thereby facilitating fixing of the elastic gasket 17 in the rear frame 16. Thirdly, the front and rear frames 13, 16 are engaged with each other, and the combined front and rear frames 13, 16 are received in the housing 12.

Referring to FIG. 8, this is an assembled view of the liquid crystal display 1, but not showing the housing 12 thereof. Also referring to FIG. 9, this is an enlarged cross-sectional taken along line IX-IX of FIG. 8. As seen, a top portion of the elastic gasket 17 is flush with a top portion of the rear frame 16, and said top portion contacts an underside of the front frame 13 and a bottom inner side of the rear frame 16. The elastic gasket 17 surrounds the liquid crystal panel 14, and provides a buffer between the liquid crystal panel 14 and the front and rear frames 13, 16. However, the underside of the front frame 13 and the top portion of the rear frame 16 abut each other. Therefore if the liquid crystal display 1 sustains external impact, either of the front and rear frames 13, 16 may cause damage to the other.

Referring to FIG. 10, another kind of conventional liquid crystal display 2 is similar to the above-described liquid crystal display 1. However, the liquid crystal display 2 includes a frame 26, a substantially rectangular elastic gasket 27, a liquid crystal panel 24, and a housing 22 defining an opening (not labeled) at a position corresponding to the liquid crystal panel 24. The elastic gasket 27 has an L-shaped through slit (not labeled) commonly defined in one long side and one short side thereof. The elastic gasket 27 surrounds the liquid crystal panel 24, and is received in the frame 26 and the housing 22. Compared to the above-described liquid crystal display 1, the liquid crystal display 2 reduces the number of frames from two to one, so that a profile of the liquid crystal display 2 is reduced.

The elastic gasket 27 surrounds the liquid crystal panel 24 and provides a buffer between the liquid crystal panel 24 and the frame 26. However, the housing 22 and the frame 26 abut each other. Therefore if the liquid crystal display 2 sustains external impact, either of the frame 26 and the housing 22 may cause damage to the other.

Accordingly, what is needed is a liquid crystal display configured to be able to provide satisfactory buffering between various of components thereof.

### SUMMARY

An exemplary liquid crystal display includes an elastic gasket, a liquid crystal panel, a frame, and a housing. The liquid crystal panel is surrounded by the elastic gasket. The liquid crystal panel and the elastic gasket are received in the frame. A top of the elastic gasket is higher than a top of the frame. The housing receives the frame, the elastic gasket, and the liquid crystal panel. An underside of a top wall of the housing abuts the top of the elastic gasket and be spaced from the top of the frame.

A detailed description of embodiments of the present invention is given below with reference to the accompanying drawings.

### BRIEF DESCRIPTION OF THE DRAWINGS

In the drawings, all the views are schematic.

FIG. 1 is an exploded, isometric view of a liquid crystal display in accordance with a first embodiment of the present invention.

FIG. 2 is an assembled view of the liquid crystal display of FIG. 1, but not showing a housing thereof.

FIG. 3 is an enlarged, cross-sectional view taken along line III-III of FIG. 2.

FIG. 4 is an isometric view of an elastic gasket of a liquid crystal display according to a second embodiment of the present invention.

FIG. 5 is an isometric view of an elastic gasket of a liquid crystal display according to a third embodiment of the present invention.

FIG. 6 is an isometric view of an elastic gasket and a frame of a liquid crystal display according to a fourth embodiment of the present invention.

FIG. 7 is an exploded, isometric view of a conventional liquid crystal display.

FIG. 8 is an assembled view of the liquid crystal display of FIG. 7, but not showing a housing thereof.

FIG. 9 is an enlarged, cross-sectional view taken along line IX-IX of FIG. 8.

FIG. 10 is an exploded, isometric view of another conventional liquid crystal display.

DETAILED DESCRIPTION OF PREFERRED EMBODIMENTS

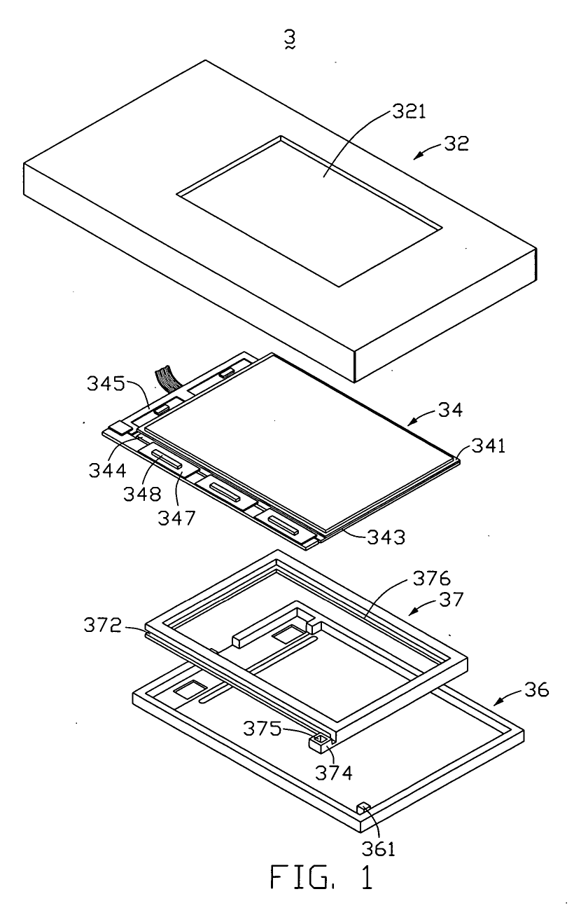

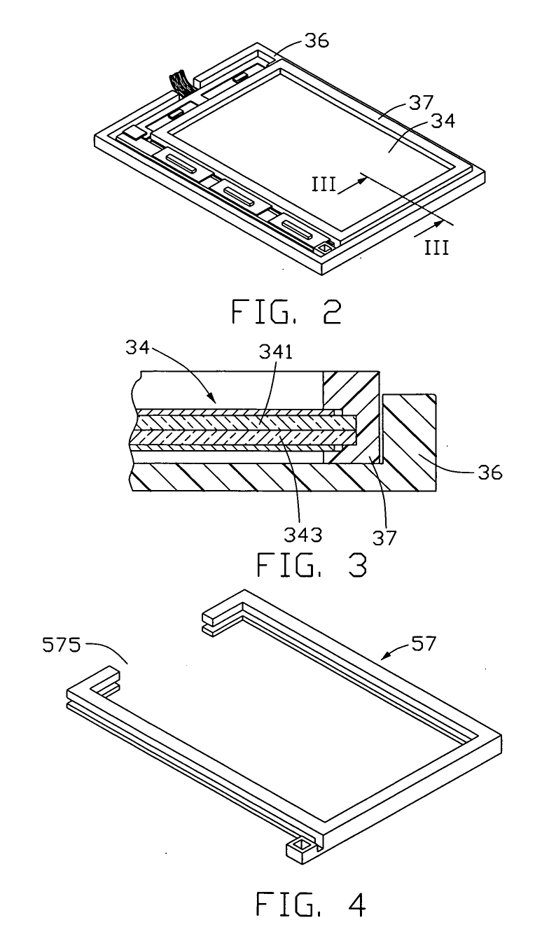

Referring to FIGS. 1 to 3, a liquid crystal display 3 in accordance with a first embodiment of the present invention includes a frame 36, a substantially rectangular elastic gasket 37, and a housing 32 having an opening 321 at a position corresponding to the liquid crystal panel 34.

The elastic gasket 37 is made from silicone rubber. The elastic gasket 37 has an L-shaped through slit 372 commonly defined in one long side and one short side thereof, and a slit 376 in an inner wall of an opposite long side thereof. The elastic gasket 37 surrounds the liquid crystal panel 34, and is received in the housing 32 and the frame 36.

The liquid crystal panel 34 includes a first substrate 341 joined on a second substrate 343. A size of the second substrate 343 is larger than that of the first substrate 341, whereby an L-shaped bonding part 344 is defined at two adjacent sides of the second substrate 343. A plurality of connecting members 347 each having a driving chip 348 disposed thereon connects the bonding part 344 with an L-shaped circuit board assembly 345 provided adjacent to the bonding part 344. The frame 36 includes a protrusion 361 at a corner thereof. The protrusion 361 is positioned according to a through hole 375 of an extension block 374 provided at a corner of the elastic gasket 37.

A process of assembly of the liquid crystal display 3 is as follows. Firstly, the liquid crystal panel 34 is surrounded by and fixed within the elastic gasket 37, such that the circuit board assembly 345 protrudes out through the slit 372 of the elastic gasket 37, and one long side of the liquid crystal panel 34 is received in the slit 376 of the elastic gasket 37. Secondly, the elastic gasket 37 and the liquid crystal panel 34 are received in the frame 36. The protrusion 361 is wedged in the through hole 375 of the extension block 374, thereby facilitating fixing of the elastic gasket 37 in the frame 36. Thirdly, the frame 36 is received in the housing 33. A top portion of the elastic gasket 37 is higher than a top portion of the frame 36 after the elastic gasket 37 and frame 36 are attached together. The elastic gasket 37 surrounds the liquid crystal panel 34, and provides a buffer between an underside of the housing 32 and the frame 36, between the housing 32 and the liquid crystal panel 34, and between the frame 36 and the liquid crystal panel 34.

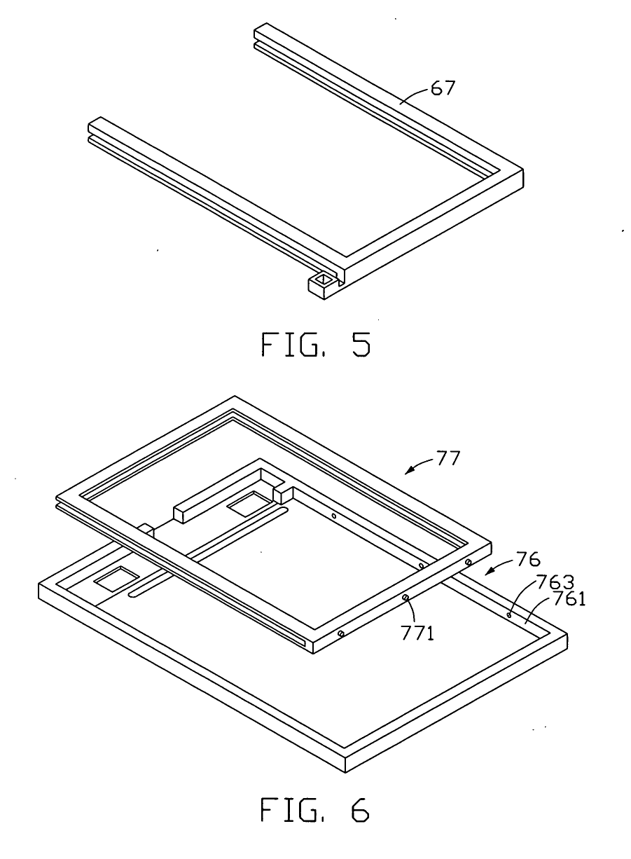

Referring to FIG. 4, this shows an elastic gasket 57 of a liquid crystal display in accordance with a second embodiment of the present invention. The elastic gasket 57 is made from silicone rubber, and is similar to the above-described elastic gasket 37. However, the elastic gasket 57 has a gap 575 in one short side thereof. The gap 575 enables a liquid crystal panel (not shown) of the liquid crystal display to be easily attached in the elastic gasket 57.

Referring to FIG. 5, this shows an elastic gasket 67 of a liquid crystal display in accordance with a third embodiment of the present invention. The elastic gasket 67 is made from silicone rubber, and is similar to the above-described elastic gasket 37. However, the elastic gasket 67 has a U-shaped frame structure. This configuration enables a liquid crystal panel (not shown) of the liquid crystal display to be easily attached in the elastic gasket 67.

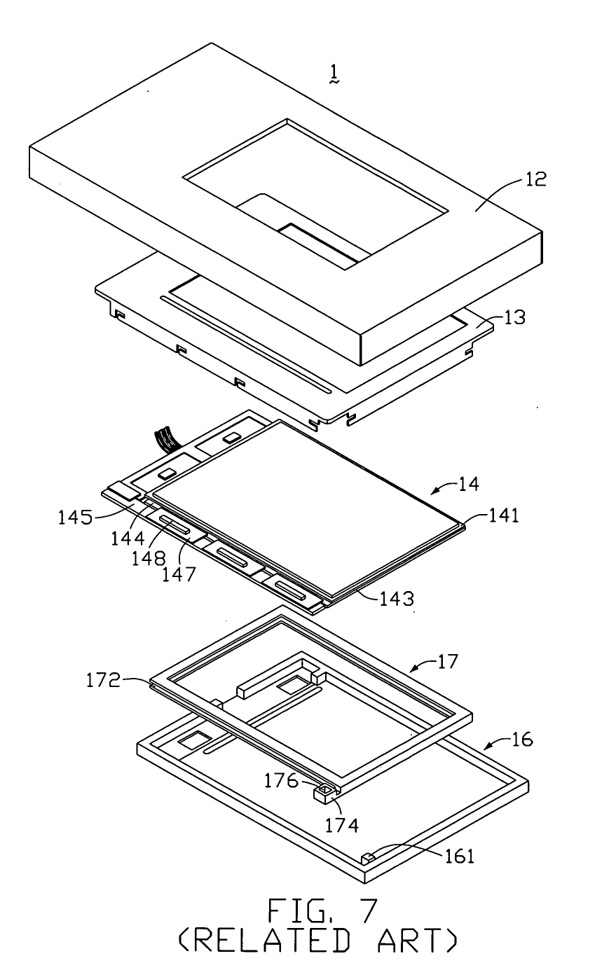

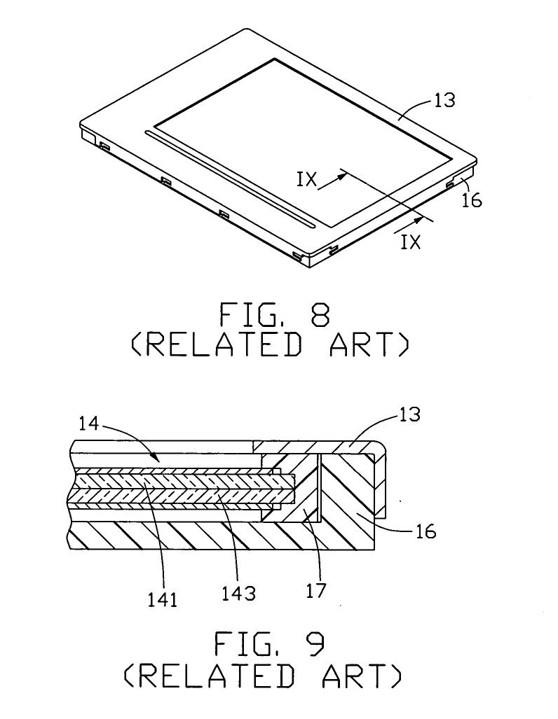

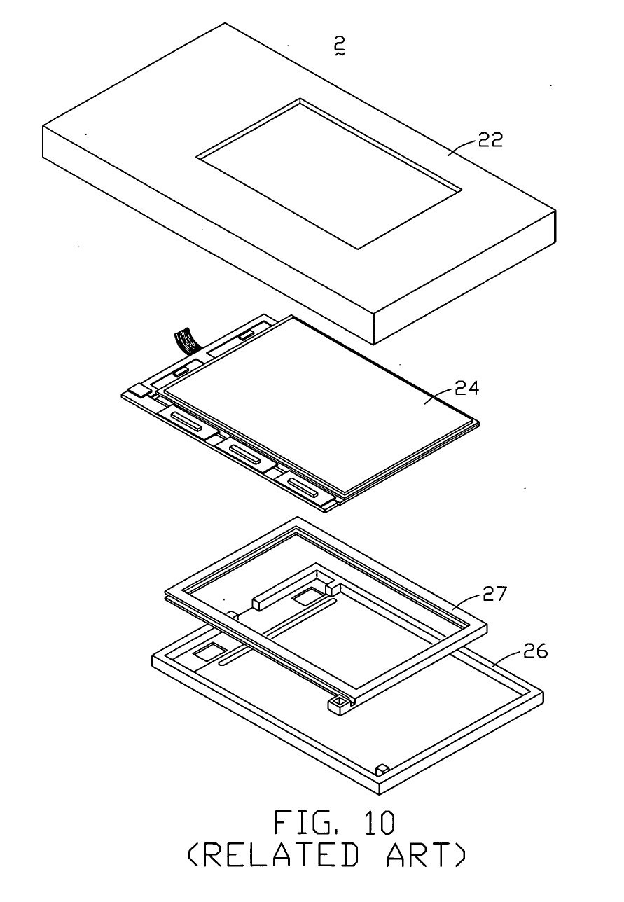

Referring to FIG. 6, this shows an elastic gasket 77 and a frame 76 of a liquid crystal display in accordance with a fourth embodiment of the present invention. The elastic gasket 77 is made from silicone rubber, and is similar to the above-described elastic gasket 37. However, the elastic gasket 77 includes a plurality of protuberances 771 extending from outside walls of one long side and one short side thereof, which sides are opposite to the long side and the short side having the L-shaped slit (not labeled). Correspondingly, the frame 76 defines a plurality of blind holes 763 in one long inner side 761 and one short inner side (not labeled) thereof. In assembly, the protuberances 771 are wedged in the blind holes 763, thereby facilitating fixing of the elastic gasket 77 in the frame 76.

In an alternative embodiment, the protuberances 771 can be formed on the frame 76, and the blind holes 763 can be defined in the elastic gasket 77 at positions according to the protuberances 771. In another alternative embodiment, there can be only a single protuberance 771 and a single blind hole 763.

While various examples and preferred embodiments have been described, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
an elastic gasket;
a liquid crystal panel at least partly surrounded by the elastic gasket;
a frame receiving the elastic gasket and the liquid crystal panel, wherein a top of the elastic gasket is higher than a top of the frame; and
a housing receiving the frame, the elastic gasket, and the liquid crystal panel, an underside of a top wall of the housing abutting the top of the elastic gasket and being spaced from the top of the frame.

2. The liquid crystal display as claimed in claim 1, wherein the elastic gasket comprises an opening.

3. The liquid crystal display as claimed in claim 1, wherein the elastic gasket is generally U-shaped.

4. The liquid crystal display as claimed in claim 1, wherein the frame comprises a protrusion, the elastic gasket comprises an extension with a through hole at a position according to the protrusion, and the protrusion is engagingly received in the through hole.

5. The liquid crystal display as claimed in claim 1, wherein the frame comprises an extension with a through hole, and the elastic gasket comprises an extension engagingly received in the through hole.

6. The liquid crystal display as claimed in claim 1, wherein the elastic gasket is made from silicone rubber.

7. The liquid crystal display as claimed in claim 1, further comprising a circuit board, wherein the circuit board is connected with the liquid crystal panel by at least one connecting member.

8. The liquid crystal display as claimed in claim 7, wherein the elastic gasket comprises a through slit, and the circuit board protrudes out through the through slit.

9. The liquid crystal display as claimed in claim 1, wherein the frame comprises a hole, and the elastic gasket comprises a protuberance engagingly received in the hole.

10. The liquid crystal display as claimed in claim 1, wherein the elastic gasket comprises a hole, and the frame comprises a protuberance engagingly received in the hole.

11. The liquid crystal display as claimed in claim 1, wherein the elastic gasket comprises a slit.

12. The liquid crystal display as claimed in claim 11, wherein one side of the liquid crystal panel is received in the slit.

13. A liquid crystal display, comprising:
an elastic gasket;
a liquid crystal panel at least partly surrounded by the elastic gasket; and
a frame;
wherein the elastic gasket and the liquid crystal panel are received within the frame, and a top of the elastic gasket is higher than a top of the frame.

14. The liquid crystal display as claimed in claim 13, furthering comprising a housing receiving the frame, the elastic gasket, and the liquid crystal panel, an underside of a top wall of the housing abutting the top of the elastic gasket and being spaced from the top of the frame.

15. The liquid crystal display as claimed in claim 13, wherein the elastic gasket comprises an opening.

16. The liquid crystal display as -claimed in claim 13, wherein the elastic gasket is generally U-shaped.

17. The liquid crystal display as claimed in claim 13, wherein the frame comprises a protrusion, the elastic gasket comprises an extension with a through hole at a position according to the protrusion, and the protrusion is engagingly received in the through hole.

18. The liquid crystal display as claimed in claim 13, wherein the frame comprises an extension with a through hole, and the elastic gasket comprises an extension engagingly received in the through hole.

19. The liquid crystal display as claimed in claim 13, wherein the elastic gasket is made from silicone rubber.

20. A liquid crystal display comprising:
an elastic gasket;
a liquid crystal panel at least partly surrounded by the elastic gasket;
a frame receiving the elastic gasket and the liquid crystal panel, wherein a top of the elastic gasket is higher than a top of the frame; and
the liquid crystal panel is located on a lower portion of the elastic gasket rather than a middle portion.
